(19) United States
(12) Patent Application Publication
(10) Pub. No.: US 2026/0120129 A1
(43) Pub. Date: Apr. 30, 2026

(54) MULTI-AGENT SYSTEM FOR PREDICTING CUSTOMER CHURN AND GENERATING RETENTION STRATEGIES

(71) Applicant: Network Innovations, LLC, Chicago, IL (US)

(72) Inventors: Fleming Shi, Scotts Valley, CA (US); Thomas Gamet, Orlando, FL (US)

(21) Appl. No.: 19/369,153

(22) Filed: Oct. 24, 2025

Related U.S. Application Data
(60) Provisional application No. 63/712,013, filed on Oct. 25, 2024.

(51) Int. Cl. G06Q 30/0201; G06N 3/0442; G06N 3/0475

(52) U.S. Cl. CPC G06Q 30/020122; G06N 3/0442; G06N 3/0475

(57) ABSTRACT

The present disclosure provides a system for predicting customer churn and generating retention strategies. The system includes a data ingestion module that collects and normalizes customer interaction data and network telemetry data comprising latency, bandwidth, and packet loss metrics. A generative artificial intelligence (GenAI) labeling agent applies chain-of-thought reasoning to categorize this data based on contextual features and temporal patterns. A machine learning module executes time-series regression models to predict customer churn probabilities using the labeled datasets. Finally, a prescriptive GenAI agent generates actionable customer retention recommendations based on these predictions, which are delivered through an automated engagement system. The system integrates real-time data processing with artificial intelligence (AI)-driven analysis to identify at-risk customers and develop targeted retention strategies.

### CROSS-REFERENCE TO RELATED APPLICATIONS

This application claims priority to U.S. Application No. 63/712,013, titled “MULTI-AGENT SYSTEM FOR PREDICTING CUSTOMER CHURN AND GENERATING RETENTION STRATEGIES USING CHAIN-OF-THOUGHT REASONING AND GENAI ORCHESTRATION”, filed Oct. 25, 2024, which is hereby incorporated by reference in its entirety.

### BACKGROUND

Customer churn in the telecommunications industry represents a significant challenge for service providers. As customers discontinue their subscriptions or switch to competitors, companies face revenue losses and increased costs associated with acquiring new customers. The ability to predict and prevent churn has become increasingly important in maintaining a stable customer base and ensuring long-term business sustainability.

Existing churn prediction models often rely on limited datasets and isolated data processing methods. These models may struggle to provide timely, actionable insights due to their inability to incorporate real-time data and external factors that influence customer behavior. Additionally, many current systems lack the capability to analyze diverse data sources simultaneously, potentially missing valuable patterns and correlations that could indicate a higher risk of churn.

The telecommunications landscape is characterized by rapidly evolving technologies and changing customer expectations. Service providers contend with factors such as network performance, customer service quality, competitive offerings, and market trends. Traditional churn prediction approaches may not adequately account for the complex interplay between these various elements, leading to less accurate forecasts and potentially ineffective retention strategies.

Another aspect of customer churn management involves the generation of effective retention strategies. Once at-risk customers are identified, service providers need to determine appropriate actions to retain them. This process often requires a nuanced understanding of individual customer preferences, historical interactions, and the potential impact of different retention offers.

Improvements are needed.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The present disclosure provides a comprehensive multi-agent system for predicting customer churn and generating retention strategies in telecommunications services. This innovative system integrates diverse data sources through a data ingestion module that collects and normalizes both batch-processed customer interaction data and real-time network telemetry metrics including latency, bandwidth utilization, and packet loss. At the core of the system, a generative artificial intelligence (GenAI) labeling agent employs structured chain-of-thought reasoning via a neural network framework to categorize and annotate the normalized data based on contextual features and temporal patterns. The labeled datasets are then processed by a machine learning module using time-series regression models to predict customer churn probabilities with high accuracy. Based on these predictions, a prescriptive GenAI agent generates machine-interpretable retention strategies and actionable customer engagement recommendations delivered through an automated engagement system. The system's effectiveness is enhanced by features such as timestamp synchronization between telemetry and interaction datasets, transformer-based neural networks for identifying sentiment indicators and anomalies, recurrent neural networks for processing time-series data, and a GenAI orchestrator that dynamically allocates computing resources based on traffic load and data freshness. By incorporating multi-channel customer interaction data and third-party market trends through an external context integrator, the system provides telecommunications providers with a powerful tool to reduce customer churn through timely, targeted interventions based on comprehensive data analysis and AI-driven insights.

These and other features and advantages are described in greater detail below.

### BRIEF DESCRIPTION OF THE DRAWINGS

The accompanying drawings, which are incorporated in and constitute a part of this specification, show embodiments and together with the description, serve to explain the principles of the methods and systems: Some features are shown by way of example, and not by limitation, in the accompanying drawings. In the drawings, like numerals reference similar elements.

FIG. 1 illustrates a block diagram of a system for predicting customer churn and generating retention strategies according to the present disclosure.

FIG. 2 illustrates a block diagram of a data ingestion module of the system of FIG. 1 according to the present disclosure.

FIG. 3 illustrates a block diagram of a GenAI labeling agent of the system of FIG. 1 according to the present disclosure.

FIG. 4 illustrates a block diagram of a machine learning module of the system of FIG. 1 according to the present disclosure.

FIG. 5 illustrates a block diagram of a prescriptive GenAI agent of the system of FIG. 1 according to the present disclosure.

FIG. 6 illustrates a block diagram of a GenAI orchestrator of the system of FIG. 1 according to the present disclosure.

FIG. 7 illustrates a system diagram showing a multi-agent architecture for customer churn prediction and retention strategy generation according to the present disclosure.

FIG. 8 illustrates a flow diagram showing customer churn prediction and retention strategy generation according to the present disclosure.

FIG. 9 illustrates a flowchart of methods for predicting customer churn and generating retention strategies according to the present disclosure.

The accompanying drawings show examples of the disclosure. It is to be understood that the examples shown in the drawings and/or discussed herein are non-exclusive and that there are other examples of how the disclosure may be practiced.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to a multi-agent system for predicting customer churn and generating retention strategies in the telecommunications industry. The system addresses challenges associated with customer churn by leveraging advanced techniques such as chain-of-thought reasoning and generative artificial intelligence (GenAI) orchestration.

The system may integrate diverse data sources to provide a comprehensive churn prediction solution. These data sources may include network telemetry, customer interaction history, and external market conditions. By combining and analyzing these varied data streams, the system may offer a more holistic view of potential churn risks.

The system may employ GenAI agents that utilize chain-of-thought reasoning to process data step-by-step. This approach may enable the agents to recognize correlations and causations across various data types, potentially offering a more contextualized understanding of churn risk. For example, an agent may analyze real-time telemetry data in conjunction with historical customer complaints and market sentiment regarding vendor performance.

GenAI orchestration may be used to coordinate multiple GenAI agents, facilitating smooth integration of real-time and batch-processed data. This orchestration may allow for dynamic and adaptive processing of data streams, which may help maintain the accuracy and timeliness of predictions and recommendations.

The system may ingest data from multiple primary sources. These sources may include real-time network telemetry delivered over an event bus, batch-processed customer interaction data, and external market data. The system may apply machine learning (ML) techniques, such as time-series regression models, to predict churn by identifying patterns in customer behavior over time.

The system may also include a component for generating actionable recommendations for extending customer retention. These recommendations may include service adjustments, personalized outreach, or discounts. Human operators may have the ability to tailor these recommendations based on customer profiles or business strategies.

By integrating diverse data types and employing advanced AI techniques, the system may provide a more comprehensive and contextually aware approach to churn prediction and retention strategy generation in the telecommunications industry.

The telecommunications industry faces significant challenges related to customer churn, which may lead to substantial revenue losses and increased costs associated with acquiring new customers. Customer churn refers to the phenomenon where subscribers discontinue their services with a particular provider, often switching to a competitor or abandoning the service entirely.

The financial impact of customer churn on telecommunications companies may be substantial. The loss of recurring revenue from departing customers may directly affect a company's bottom line. Additionally, the costs involved in acquiring new customers to replace those who have churned may be considerably higher than retaining existing ones, potentially straining marketing budgets and reducing overall profitability.

Existing churn prediction models in the telecommunications industry may have limitations that hinder their effectiveness. These models may rely on limited datasets, which may not provide a comprehensive view of customer behavior and satisfaction. The restricted scope of data inputs may lead to incomplete or inaccurate predictions of churn risk.

Furthermore, many current churn prediction systems may lack real-time responsiveness. This limitation may prevent telecommunications companies from identifying and addressing potential churn risks as they emerge. The delay between data collection, analysis, and action may result in missed opportunities to retain customers who are at risk of churning.

Existing models may fail to incorporate crucial external factors such as market trends and vendor performance. These external influences may play a significant role in customer satisfaction and loyalty, yet their omission from churn prediction models may lead to incomplete risk assessments.

The inability of current systems to provide timely, actionable insights may leave telecommunications organizations unable to proactively address churn risk. This reactive approach to customer retention may result in higher churn rates and increased customer acquisition costs, potentially impacting long-term business sustainability and growth.

Addressing these challenges may require more sophisticated approaches to churn prediction and customer retention in the telecommunications industry. Improved models that incorporate diverse data sources, real-time analysis, and external market factors may enable more effective strategies for reducing customer churn and maintaining a stable subscriber base.

The proposed multi-agent system employs GenAI agents with chain-of-thought reasoning and GenAI orchestration to predict customer churn and generate retention strategies in the telecommunications industry. This system integrates diverse data sources to provide comprehensive churn prediction and retention solutions.

The system may comprise a data ingestion module configured to collect and batch-process customer interaction data and real-time or near real-time network telemetry data from distributed sources. The data ingestion module may be further configured to normalize the collected data. The network telemetry data may comprise metrics such as latency, bandwidth utilization, and packet loss.

The system may include a GenAI labeling agent implemented via a neural network framework. This GenAI labeling agent may be configured to apply structured chain-of-thought reasoning to categorize and annotate the normalized data into labeled datasets based on contextual features and temporal patterns.

An ML module may be operatively coupled to the GenAI labeling agent. The ML module may be configured to execute time-series regression models trained to predict customer churn probabilities using the labeled datasets.

The system may include a prescriptive GenAI agent configured to generate machine-interpretable retention strategies and actionable customer engagement recommendations based on output from the ML module. These recommendations may be delivered via an automated engagement system.

The integration of diverse data sources and advanced artificial intelligence (AI) techniques may enable the system to provide a more comprehensive and contextually aware approach to churn prediction and retention strategy generation in the telecommunications industry. By leveraging real-time network telemetry data alongside batch-processed customer interaction data, the system may offer timely and accurate insights into customer behavior and potential churn risks.

The system may employ two techniques to enable comprehensive churn prediction and retention strategy generation: Chain-of-Thought Reasoning and GenAI Orchestration.

Chain-of-Thought Reasoning may be applied to structure and label the collected data. This technique enables GenAI agents to process data in a step-by-step manner, analyzing various data types such as real-time telemetry, customer interaction histories, and external market conditions. By breaking down the analysis into logical steps, chain-of-thought reasoning may allow the system to recognize complex correlations and causations across diverse datasets.

The chain-of-thought reasoning process may involve multiple stages of analysis. For example, a GenAI agent may first examine network performance metrics from real-time telemetry data. The agent may then correlate these metrics with historical customer complaints or survey results. Finally, the agent may consider how these factors relate to broader market trends or vendor performance data.

This structured approach to data analysis may provide a more holistic and contextualized understanding of churn risk. By considering multiple factors and their interrelationships, the system may identify subtle patterns or early warning signs that might be missed by more simplistic analysis methods.

GenAI Orchestration may be used to coordinate multiple GenAI agents, facilitating smooth integration of real-time and batch-processed data. This technique may involve a higher-level orchestrator component that manages the activities of various specialized GenAI agents.

The orchestrator may dynamically allocate tasks to different agents based on the nature of the incoming data and the current processing requirements. For instance, one agent may focus on analyzing real-time network telemetry, while another processes historical customer interactions. The orchestrator may then integrate the outputs from these agents to form a comprehensive view of potential churn risks.

GenAI Orchestration may enable adaptive processing of data streams. The orchestrator may adjust processing priorities or resource allocation based on detected patterns or emerging trends in the data. This dynamic approach may help promote accurate and up-to-date predictions and recommendations, even as conditions change over time.

The combination of Chain-of-Thought Reasoning and GenAI Orchestration may allow the system to handle complex, multi-faceted analyses while maintaining efficiency and responsiveness. These techniques may work together to provide a more nuanced and actionable understanding of customer churn risks in the telecommunications industry.

The system may ingest data from three primary sources to enable comprehensive churn prediction and retention strategy generation: real-time network telemetry, batch-processed customer interaction data, and external market data.

Real-time network telemetry data may be collected from customer premise equipment (CPE) and service provider infrastructure nodes. This telemetry data may include metrics such as latency, bandwidth utilization, and packet loss. The network telemetry data may be ingested via secure application programming interface (API) endpoints utilizing low-latency protocols. This approach may allow for rapid ingestion and processing of real-time network performance data.

Batch-processed customer interaction data may comprise multi-channel inputs from various customer touchpoints. These inputs may include emails, chat transcripts, call center logs, and structured survey responses. By aggregating data from multiple interaction channels, the system may gain a more comprehensive view of customer sentiment and experiences over time.

External market data may be incorporated through an external context integrator. This component may be configured to ingest third-party market trend data and vendor performance analytics. The integration of external market data may provide additional context for churn prediction and retention recommendation processes.

The real-time network telemetry data may offer insights into the current quality of service experienced by customers. The batch-processed customer interaction data may reveal patterns in customer satisfaction and pain points over time. The external market data may help contextualize customer behavior within broader industry trends and competitive landscapes.

By combining these diverse data sources, the system may develop a more nuanced understanding of factors contributing to customer churn. This multi-faceted approach to data ingestion may enable more accurate churn predictions and more effective retention strategies tailored to specific customer needs and market conditions.

The system may employ advanced data processing and analysis techniques to predict customer churn and generate retention strategies. These techniques may involve multiple stages, including data collection, labeling, and analysis.

The data ingestion process may involve timestamping and formatting collected data according to a unified schema. This approach may enable real-time or near real-time synchronization between telemetry and interaction datasets. By aligning diverse data streams temporally and structurally, the system may facilitate more accurate and timely analysis of customer behavior patterns.

The GenAI labeling agent may utilize a transformer-based neural network model to process and annotate the collected data. This model may be trained to identify various indicators within customer interaction records, including sentiment indicators, anomaly markers, and temporal dependencies. The ability to recognize these complex patterns may allow for more nuanced categorization and labeling of customer data.

The transformer-based model may analyze textual data from customer interactions, such as support tickets or chat logs. The model may identify positive or negative sentiment expressed by customers, flag unusual patterns that could indicate potential issues, and recognize how customer attitudes or behaviors change over time.

The machine learning (ML) module may comprise a recurrent neural network (RNN) or long short-term memory (LSTM) network. These types of neural networks may be particularly well-suited for processing time-series sequences of labeled customer activity data. The RNN or LSTM architecture may allow the system to capture and analyze temporal patterns in customer behavior, potentially revealing trends or changes that could indicate increased churn risk.

The ML module may process sequences of customer interactions, network usage patterns, and other relevant data points over time. By analyzing these sequences, the system may identify patterns that precede customer churn, such as declining engagement or increasing frequency of support requests.

Based on the analysis performed by the ML module, a prescriptive GenAI agent may generate actionable recommendations for customer retention. These recommendations may be derived from patterns identified in the labeled and analyzed data, taking into account factors such as customer sentiment, usage trends, and historical retention strategies.

The prescriptive GenAI agent may consider multiple factors when generating recommendations. For example, the agent may analyze the effectiveness of past retention strategies for customers with similar behavior patterns. The agent may also take into account current network performance metrics and customer sentiment indicators to tailor recommendations to specific customer needs or concerns.

The recommendations generated by the prescriptive GenAI agent may include proactive measures to address potential issues before they lead to churn. These measures may include targeted service improvements, personalized communication strategies, or special offers designed to increase customer satisfaction and loyalty.

The system's ability to process and analyze diverse data streams in real-time or near real-time may allow for dynamic updating of churn predictions and retention recommendations. This ongoing analysis and adaptation may enable telecommunications providers to respond quickly to changing customer needs and market conditions, potentially improving overall customer retention rates.

The system for predicting customer churn and generating retention strategies may incorporate several key differentiators that contribute to its effectiveness in addressing customer retention challenges in the telecommunications industry.

The system may employ holistic data integration techniques to analyze multiple data sources simultaneously. This approach may allow for a comprehensive view of customer behavior by combining real-time network telemetry, historical customer interactions, and external market data. By integrating diverse data types, the system may identify complex patterns and relationships that might not be apparent when examining each data source in isolation.

The system may offer real-time or near real-time churn prediction capabilities by processing network telemetry data as it is generated. This real-time analysis may enable the detection of immediate changes in customer behavior or service quality that could indicate increased churn risk. By providing timely insights, the system may allow telecommunications providers to respond rapidly to potential issues before they escalate.

Contextual awareness may be a feature of the system, achieved through the incorporation of external market data and vendor performance analytics. This broader context may help in interpreting customer behavior within the framework of industry trends and competitive landscapes. For example, the system may consider factors such as market-wide service disruptions or competitor promotions when assessing churn risk for individual customers.

The system may generate proactive retention strategies based on its predictive analysis. Rather than simply identifying customers at risk of churn, the system may provide actionable recommendations for retaining these customers. These recommendations may be tailored to address specific issues or concerns identified through the analysis of customer data and network performance metrics.

The system may allow for operator customization of retention strategies. This feature may enable human operators to adjust and refine the system's recommendations based on their expertise or specific business priorities. The ability to customize strategies may ensure that the system's outputs align with the telecommunications provider's overall retention goals and customer relationship management approach.

The prescriptive GenAI agent within the system may be configured to rank customer retention recommendations. This ranking may be based on a calculated retention efficacy score derived from prior action outcomes. By evaluating the effectiveness of past retention efforts, the system may continuously refine its recommendations to focus on strategies with the highest probability of success.

The system may include an operational dashboard that presents predictions and recommendations for easy review and action by customer success teams. This dashboard may provide a user-friendly interface for accessing the system's insights and implementing retention strategies. The presentation of data through the dashboard may facilitate rapid decision-making and allow customer success teams to prioritize their efforts effectively.

By combining these differentiating features, the system may offer a comprehensive and adaptive approach to customer churn prediction and retention in the telecommunications industry. The integration of diverse data sources, real-time analysis capabilities, and customizable retention strategies may provide telecommunications providers with powerful tools for maintaining customer relationships and reducing churn rates.

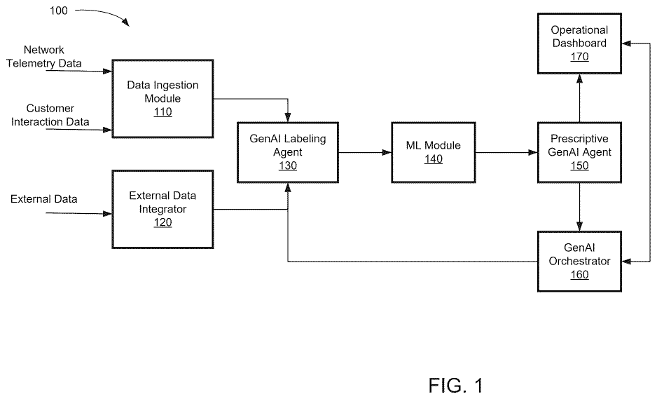

A system 100 for predicting customer churn and generating retention strategies may comprise several interconnected components, as illustrated in FIG. 1. A data ingestion module 110 may collect and process customer interaction data and network telemetry data from various sources. The data ingestion module 110 may be configured to handle both batch-processed information and real-time or near real-time data streams.

An external data integrator 120 may be included in the system 100 to incorporate third-party market trend data and vendor performance analytics. This component may enrich the analysis by providing broader context to customer behavior and market conditions.

A GenAI labeling agent 130 may be implemented to apply structured reasoning to categorize and annotate the data processed by the data ingestion module 110 and the external data integrator 120. The GenAI labeling agent 130 may utilize advanced neural network techniques to identify patterns and relationships within the data.

The system 100 may include an ML module 140 operatively coupled to the GenAI labeling agent 130. The ML module 140 may execute predictive models trained on the labeled datasets to forecast customer churn probabilities.

Based on the output from the ML module 140, a prescriptive GenAI agent 150 may generate actionable recommendations for customer retention. These recommendations may be tailored to address specific risk factors identified in the churn predictions.

A GenAI orchestrator 160 may be incorporated into the system 100 to manage the coordination between various components. The GenAI orchestrator 160 may be configured to manage prioritization and parallelization of data labeling and model inference operations across distributed computing nodes. The GenAI orchestrator 160 may dynamically allocate compute resources based on factors such as traffic load, model execution latency, and data freshness indicators.

An operational dashboard 170 may serve as the interface for displaying system outputs and recommendations. The operational dashboard 170 may present churn predictions and suggested retention strategies in a format accessible to customer success teams and decision-makers.

The components of the system 100 may be arranged in a sequential flow, with data moving from input sources through various processing stages to the final output display. Multiple feedback loops may be incorporated, particularly between the GenAI orchestrator 160, prescriptive GenAI agent 150, and operational dashboard 170, allowing for continuous refinement of analysis and recommendations.

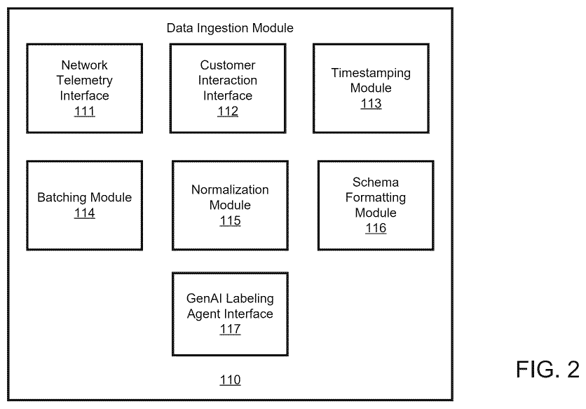

The data ingestion module 110 of the system 100 may be configured to collect and process data from various sources, as illustrated in FIG. 2. The data ingestion module 110 may comprise several subcomponents, each serving a specific function in the data processing pipeline.

A network telemetry interface 111 may be included in the data ingestion module 110 to handle the ingestion of real-time or near real-time network performance data. The network telemetry interface 111 may be configured to receive metrics such as latency, bandwidth utilization, and packet loss from network infrastructure components.

A customer interaction interface 112 may be incorporated into the data ingestion module 110. The customer interaction interface 112 may be responsible for collecting and processing batch data related to customer interactions, such as support tickets, survey responses, and communication logs.

The data ingestion module 110 may include a timestamping module 113. The timestamping module 113 may apply temporal markers to incoming data, enabling accurate tracking of when events occurred or when data was received. This temporal information may be used for time-series analysis and facilitating data consistency across different sources.

A batching module 114 may be present within the data ingestion module 110. The batching module 114 may aggregate incoming data into groups or batches for more efficient processing. The batching module 114 may organize data based on time intervals, data volume, or other predefined criteria.

The data ingestion module 110 may incorporate a normalization module 115. The normalization module 115 may be responsible for standardizing data formats across different sources. This standardization process may facilitate processing data from diverse origins uniformly by subsequent components of the system 100.

A schema formatting module 116 may be included in the data ingestion module 110. The schema formatting module 116 may structure the normalized data according to predefined schemas. This structured formatting may facilitate easier data analysis and integration with other components of the system 100.

The data ingestion module 110 may feature a GenAI labeling agent interface 117. The GenAI labeling agent interface 117 may serve as a communication channel between the data ingestion module 110 and the GenAI labeling agent 130. This interface may enable the transfer of processed and structured data for further analysis and labeling.

The components within the data ingestion module 110 may work together to process and prepare data for further analysis by other modules of the system 100. The arrangement of these components may allow for systematic data processing, from initial ingestion through various transformation stages before passing the processed data to other system components such as the GenAI labeling agent 130 or the ML module 140.

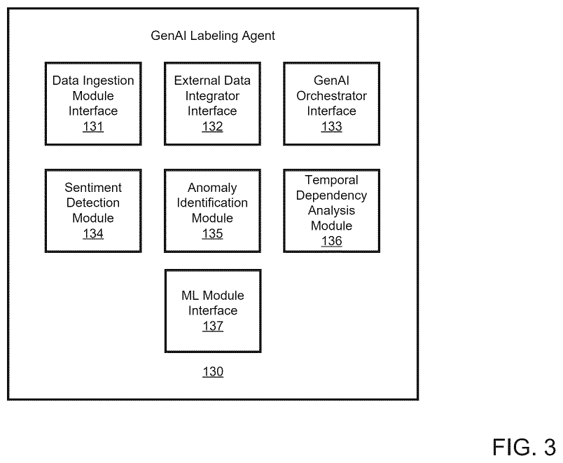

The GenAI labeling agent 130 of the system 100 may be configured to process and analyze data using various modules, as illustrated in FIG. 3. The GenAI labeling agent 130 may comprise several interfaces and processing components arranged to handle different aspects of data processing and analysis.

A data ingestion module interface 131 may be included in the GenAI labeling agent 130 to facilitate communication with the data ingestion module 110. The data ingestion module interface 131 may be responsible for receiving processed and structured data from the data ingestion module 110 for further analysis and labeling.

An external data integrator interface 132 may be incorporated into the GenAI labeling agent 130. The external data integrator interface 132 may enable the GenAI labeling agent 130 to receive and process data from the external data integrator 120, allowing for the integration of third-party market trend data and vendor performance analytics into the labeling process.

The GenAI labeling agent 130 may include a GenAI orchestrator interface 133. The GenAI orchestrator interface 133 may facilitate communication between the GenAI labeling agent 130 and the GenAI orchestrator 160, enabling coordinated data processing and analysis operations across the system 100.

A sentiment detection module 134 may be present within the GenAI labeling agent 130. The sentiment detection module 134 may be responsible for analyzing the sentiment in customer interaction data, such as support tickets or survey responses. The sentiment detection module 134 may use natural language processing techniques to identify positive, negative, or neutral sentiments expressed by customers.

The GenAI labeling agent 130 may incorporate an anomaly identification module 135. The anomaly identification module 135 may be configured to detect unusual patterns or behaviors in the data. This module may analyze various data points, including network performance metrics and customer usage patterns, to identify potential issues or deviations from normal behavior.

A temporal dependency analysis module 136 may be included in the GenAI labeling agent 130. The temporal dependency analysis module 136 may be responsible for examining time-based relationships in the data. This module may analyze sequences of events or changes in customer behavior over time, potentially revealing trends or patterns that could indicate increased churn risk.

The GenAI labeling agent 130 may feature a machine learning module interface 137. The machine learning module interface 137 may serve as a communication channel between the GenAI labeling agent 130 and the machine learning module 140. This interface may enable the transfer of labeled and processed data for further analysis and churn prediction.

The components within the GenAI labeling agent 130 may work together to process and analyze data from various sources. The arrangement of these components may allow for comprehensive data handling and analysis, with each module performing specific functions while maintaining communication through their respective interfaces. The GenAI labeling agent 130 may play a role in preparing data for subsequent churn prediction and retention strategy generation by the ML module 140 and the prescriptive GenAI agent 150.

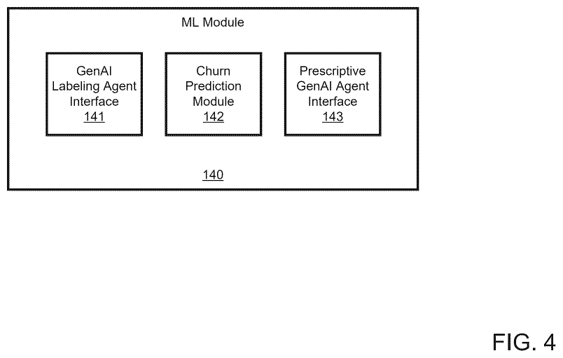

The ML module 140 of the system 100 may be configured to perform churn prediction based on the labeled data provided by the GenAI labeling agent 130, as illustrated in FIG. 4. The ML module 140 may comprise several components that work together to process data and generate churn predictions.

The ML module 140 may include a GenAI labeling agent interface 141, which may facilitate communication between the machine learning module 140 and the GenAI labeling agent 130. The GenAI labeling agent interface 141 may be responsible for receiving labeled datasets from the GenAI labeling agent 130 for further analysis and churn prediction.

The ML module 140 may incorporate a churn prediction module 142. The churn prediction module 142 may be configured to process the labeled data received through the GenAI labeling agent interface 141 and generate predictions about customer churn probabilities. The churn prediction module 142 may utilize various machine learning algorithms, such as time-series regression models, to analyze patterns in customer behavior and identify factors that may contribute to churn risk.

The ML module 140 may also include a prescriptive GenAI agent interface 143. The prescriptive GenAI agent interface 143 may enable communication between the ML module 140 and the prescriptive GenAI agent 150. This interface may be responsible for transmitting churn predictions and related insights to the prescriptive GenAI agent 150 for the generation of retention strategies.

The churn prediction module 142 may employ recurrent neural network (RNN) or long short-term memory (LSTM) architectures to process time-series sequences of labeled customer activity data. These neural network models may be particularly well-suited for capturing temporal patterns in customer behavior, potentially revealing trends or changes that could indicate increased churn risk.

The ML module 140 may be designed to handle large volumes of data efficiently. The ML module 140 may utilize distributed computing techniques to process data across multiple nodes, enabling faster analysis and prediction generation. The GenAI orchestrator 160 may play a role in managing the allocation of computing resources for the ML module 140, facilitating improved performance based on current system load and data processing requirements.

The churn prediction module 142 may be configured to generate various types of outputs. These outputs may include numerical probabilities of churn for individual customers or customer segments. The module may also identify specific factors or events that contribute to increased churn risk, providing valuable insights for retention strategy development.

The ML module 140 may incorporate feedback mechanisms to continuously improve its predictive accuracy. The ML module 140 may compare its predictions against actual customer behavior over time, using this information to refine its models and adjust its prediction algorithms.

The ML module 140 may be designed to work in conjunction with other components of the system 100. For example, the ML module 140 may receive preprocessed and labeled data from the data ingestion module 110 and the GenAI labeling agent 130. The churn predictions generated by the ML module 140 may then be used by the prescriptive GenAI agent 150 to develop targeted retention strategies.

The ML module 140 may be capable of handling both structured and unstructured data. Structured data may include numerical metrics from network telemetry, while unstructured data may encompass text from customer interactions or survey responses. The ML module's 140 ability to process diverse data types may contribute to more comprehensive and accurate churn predictions.

The ML module 140 may also be designed with scalability in mind. As the volume of data or the complexity of analysis requirements increases, the ML module 140 may be capable of adapting to handle increased workloads. This scalability may be achieved through modular design and the ability to leverage additional computing resources as needed.

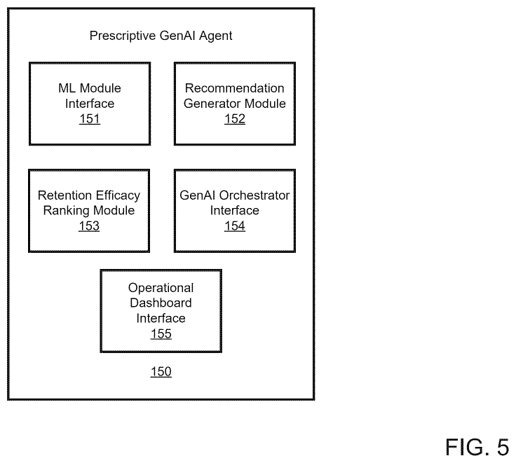

The prescriptive GenAI agent 150 of the system 100 may be configured to generate and rank recommendations for customer retention based on the output from the ML module 140, as illustrated in FIG. 5. The prescriptive GenAI agent 150 may comprise several components that work together to process churn predictions and generate actionable retention strategies.

The prescriptive GenAI agent 150 may include an ML module interface 151, which may facilitate communication between the prescriptive GenAI agent 150 and the ML module 140. The ML module interface 151 may be responsible for receiving churn predictions and related insights from the ML module 140 for further processing and strategy generation.

The prescriptive GenAI agent 150 may incorporate a recommendation generator module 152. The recommendation generator module 152 may be configured to process the churn predictions received through the ML module interface 151 and generate specific recommendations for customer retention. The recommendation generator module 152 may utilize various algorithms and heuristics to develop tailored strategies based on the identified churn risk factors and customer characteristics.

The prescriptive GenAI agent 150 may also include a retention efficacy ranking module 153. The retention efficacy ranking module 153 may be responsible for evaluating and ranking the recommendations generated by the recommendation generator module 152. The retention efficacy ranking module 153 may calculate a retention efficacy score for each recommendation based on historical data and predicted outcomes.

A GenAI orchestrator interface 154 may be present within the prescriptive GenAI agent 150. The GenAI orchestrator interface 154 may enable communication between the prescriptive GenAI agent 150 and the GenAI orchestrator 160. This interface may facilitate the coordination of recommendation generation and ranking processes with other system components.

The prescriptive GenAI agent 150 may feature an operational dashboard interface 155. The operational dashboard interface 155 may serve as a communication channel between the prescriptive GenAI agent 150 and the operational dashboard 170. This interface may be responsible for transmitting ranked recommendations and related insights to the operational dashboard 170 for presentation to users, such as users associated with customer success teams and decision-makers.

The recommendation generator module 152 may employ advanced natural language processing techniques to formulate retention strategies in human-readable formats. These recommendations may include specific actions such as personalized offers, service upgrades, or proactive customer outreach initiatives.

The retention efficacy ranking module 153 may utilize ML algorithms to continuously refine its ranking criteria based on the outcomes of implemented retention strategies. The module may consider factors such as customer lifetime value, implementation cost, and probability of success when calculating retention efficacy scores.

The prescriptive GenAI agent 150 may be designed to handle real-time updates and adjustments to retention strategies. As new data becomes available or market conditions change, the agent may dynamically update its recommendations to ensure their relevance and effectiveness.

The prescriptive GenAI agent 150 may incorporate feedback mechanisms to learn from the success or failure of implemented retention strategies. This feedback may be used to improve future recommendations and refine the agent's decision-making processes.

The prescriptive GenAI agent 150 may be capable of generating recommendations at various levels of granularity. The agent may provide broad strategies for customer segments as well as highly personalized recommendations for individual high-value customers.

The components within the prescriptive GenAI agent 150 may work together to process churn predictions, generate retention strategies, and rank these strategies based on their predicted efficacy. The arrangement of these components may allow for comprehensive strategy development and prioritization, enabling customer success teams to focus their efforts on the most promising retention initiatives.

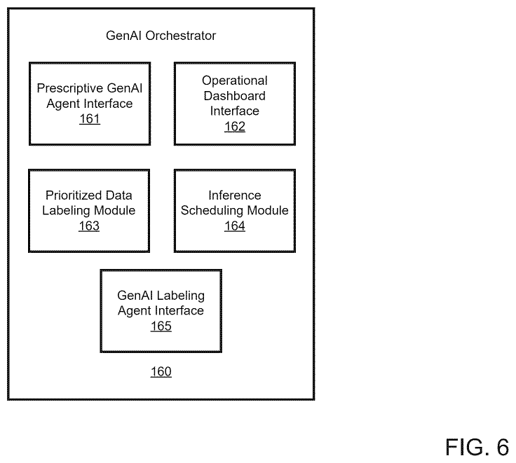

The GenAI orchestrator 160 of the system 100 may be configured to coordinate various AI processing functions and interface with other system components, as illustrated in FIG. 6. The GenAI orchestrator 160 may comprise several interfaces and modules arranged to manage prioritization and parallelization of data labeling and model inference operations across distributed computing nodes.

The GenAI orchestrator 160 may include a prescriptive GenAI agent interface 161, which may facilitate communication between the GenAI orchestrator 160 and the prescriptive GenAI agent 150. The prescriptive GenAI agent interface 161 may be responsible for receiving retention strategy recommendations and coordinating their implementation with other system components.

The GenAI orchestrator 160 may incorporate an operational dashboard interface 162. The operational dashboard interface 162 may enable communication between the GenAI orchestrator 160 and the operational dashboard 170. This interface may be responsible for transmitting orchestration status updates and system performance metrics to the operational dashboard 170 for monitoring and management purposes.

The GenAI orchestrator 160 may also include a prioritized data labeling module 163. The prioritized data labeling module 163 may be configured to manage the prioritization of data labeling tasks across the system 100. The prioritized data labeling module 163 may use ML algorithms to determine useful data for labeling based on factors such as data freshness, relevance to current churn prediction tasks, and potential impact on retention strategies.

An inference scheduling module 164 may be present within the GenAI orchestrator 160. The inference scheduling module 164 may be responsible for coordinating the execution of ML models and AI inference tasks across the system 100. The inference scheduling module 164 may adjust the allocation of computing resources based on the current system load, model complexity, and urgency of prediction tasks.

The GenAI orchestrator 160 may feature a GenAI labeling agent interface 165. The GenAI labeling agent interface 165 may serve as a communication channel between the GenAI orchestrator 160 and the GenAI labeling agent 130. This interface may be responsible for coordinating data labeling tasks and supporting efficient distribution of labeled data to the appropriate system components for further processing.

The GenAI orchestrator 160 may dynamically allocate compute resources based on factors such as traffic load, model execution latency, and data freshness indicators. The GenAI orchestrator 160 may monitor system performance metrics and adjust resource allocation in real-time or near real-time to improve overall system efficiency and responsiveness.

The GenAI orchestrator 160 may be designed to handle complex workflows involving multiple AI agents and processing stages. The GenAI orchestrator 160 may use advanced scheduling algorithms to manage dependencies between different processing tasks, ensuring that data flows smoothly through the system 100 from ingestion to final recommendation generation.

The components within the GenAI orchestrator 160 may work together to coordinate the activities of various AI agents and processing modules within the system 100. The arrangement of these components may allow for efficient management of system resources, optimized data processing workflows, and seamless integration of AI-driven insights across different stages of the churn prediction and retention strategy generation process.

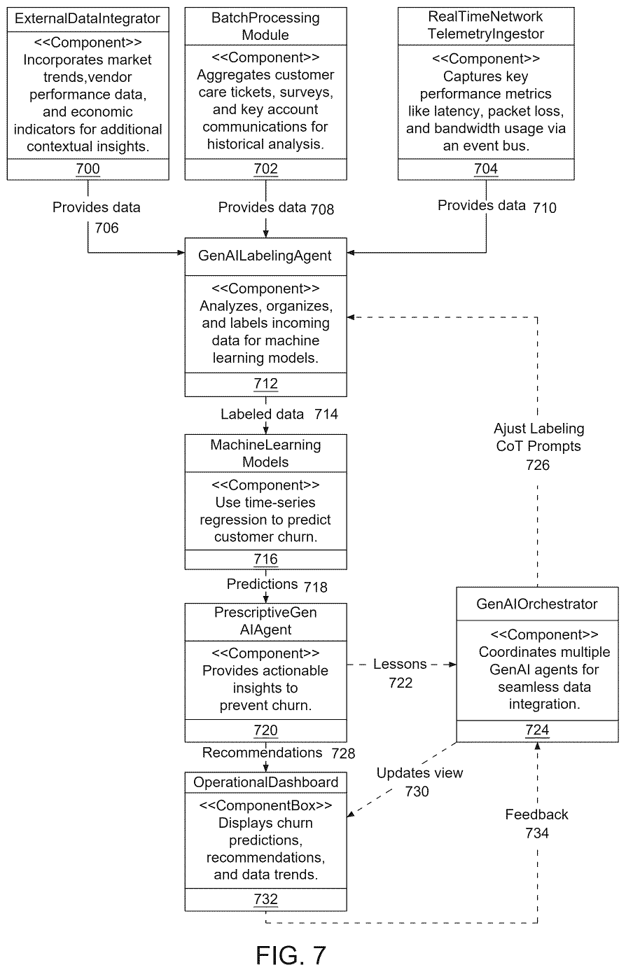

FIG. 7 illustrates a multi-agent architecture for customer churn prediction and retention strategy generation. This architecture may comprise several interconnected components that work together to process data, generate insights, and provide actionable recommendations.

The architecture may include three primary data input components: an External Data Integrator 700, a Batch Processing Module 702, and a Real-Time Network Telemetry Ingestor 704. The External Data Integrator 700 may process market trends and vendor performance data, providing contextual information 706 for the analysis. The Batch Processing Module 702 may handle customer care data and surveys, offering historical insights 708 into customer interactions. The Real-Time Network Telemetry Ingestor 704 may capture performance metrics 710, enabling immediate detection of potential issues, such as latency, packet loss, bandwidth usage via an event bus, etc.

These three components may provide data flows that converge into a GenAI Labeling Agent 712. The GenAI Labeling Agent 712 may analyze, organize, and label incoming data for ML Models 716. The labeled data 714 may then flow to one or more ML Models 716 that use time-series regression to predict customer churn.

The architecture may incorporate a Prescriptive GenAI Agent 720 to process actionable insights for preventing churn. The Prescriptive GenAI Agent 720 may receive predictions 718 from the ML Models 716. The Prescriptive GenAI Agent 720 may interface with a GenAI Orchestrator component 724, which may coordinate multiple GenAI agents for seamless data integration. The GenAI Orchestrator may maintain bidirectional communication with the Prescriptive GenAI Agent 720, allowing for dynamic adjustments to the analysis process. The Prescriptive GenAi Agent 720 may provide lessons 722 to the GenAI Orchestrator 724. The Prescriptive GenAi Agent 720 may provide recommendations 728 to an Operational Dashboard 732. The GenAI Orchestrator 724 may cause chain-of-thought (CoT) prompts used by the GenAI Labeling Agent 712 to be adjusted 726. The GenAI Orchestrator 724 may provide view updates 730 to an Operational Dashboard 732.

The Operational Dashboard 732 may display churn predictions, recommendations, and data metrics. The Operational Dashboard 732 may provide feedback 734 that loops back to the GenAI Orchestrator 724, potentially creating a continuous improvement cycle.

The architecture may dynamically adjust its processing based on incoming data and detected patterns. For example, the GenAI Orchestrator 724 may prioritize certain types of data or analysis tasks based on real-time telemetry inputs or emerging trends identified in batch-processed customer interaction data.

The multi-agent architecture may allow for parallel processing of different data streams while maintaining coordination through the orchestrator component. This structure may enable continuous data processing and validation while incorporating feedback mechanisms to potentially improve prediction accuracy and recommendation relevance over time.

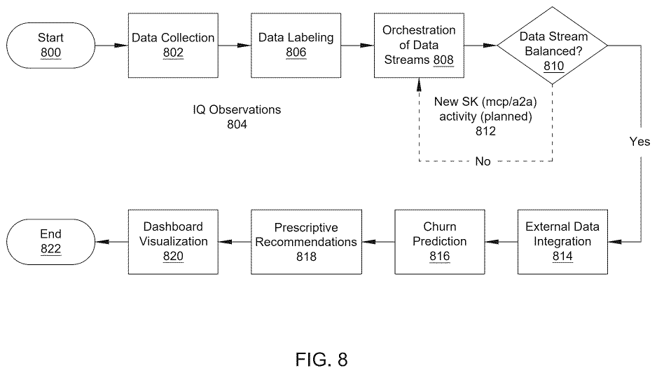

FIG. 8 illustrates a flow diagram showing a method for customer churn prediction and retention strategy generation. The method begins with a Start point 800 and proceeds through a series of interconnected processing stages.

A first stage, data collection 802, involves gathering both real-time network telemetry data and batch-processed customer interaction data. The network telemetry data may include metrics such as latency, bandwidth utilization, and packet loss from customer premise equipment and service provider infrastructure. The customer interaction data may comprise multi-channel inputs including emails, chat transcripts, call center logs, and structured survey responses. Intelligent observations (or IQ observations) 804 may be determined during data collection 802. Intelligent observations 804 may include coupling related data (such as telemetry data indicative of a problem in a region and complaints from customers in the region), determining context, etc.

Following data collection 802, data labeling 806 occurs, where the GenAI labeling agent may apply structured chain-of-thought reasoning to categorize and annotate the collected data. The GenAI labeling agent may utilize a transformer-based neural network model to identify sentiment indicators, anomaly markers, and temporal dependencies within the customer data, creating labeled datasets for further analysis.

The method then proceeds to orchestration of data streams 808, where the GenAI orchestrator may coordinate the integration of real-time and batch-processed data streams. The GenAI orchestrator may manage prioritization and parallelization of data labeling and model inference operations across distributed computing nodes, dynamically allocating compute resources based on traffic load, model execution latency, and data freshness indicators.

A decision point 810branches based on whether the data streams are properly balanced for efficient processing. The GenAI orchestrator may evaluate the current system load and data processing requirements, potentially adjusting resource allocation to facilitate efficient data flow. If the streams are not balanced, the process may return to the orchestration of data streams 808 for rebalancing before proceeding.

Once the data streams are properly balanced, external data integration 814 occurs, where the external data integrator may incorporate third-party market trend data and vendor performance analytics into the analysis pipeline. This integration provides broader context to customer behavior and market conditions, enriching the dataset for more comprehensive churn prediction.

The method then advances to churn prediction 816, where the ML module may execute time-series regression models to predict customer churn probabilities. The ML module may employ recurrent neural network (RNN) or long short-term memory (LSTM) architectures to process time-series sequences of labeled customer activity data, identifying patterns that indicate increased churn risk.

Based on the churn prediction 816, prescriptive recommendations 818 may be generated by the prescriptive GenAI agent. The prescriptive GenAI agent may produce machine-interpretable retention strategies and actionable customer engagement recommendations. These recommendations may be ranked based on a calculated retention efficacy score derived from prior action outcomes, ensuring that the most effective strategies are prioritized.

The final stage before completion is dashboard visualization 820, where the operational dashboard may present the churn prediction 816 and prescriptive recommendations 818 in a format accessible to customer success teams and decision-makers. The operational dashboard may display various metrics and visualizations to help users understand churn risks and evaluate potential retention strategies.

The method may conclude at an end point 822, completing the customer churn risk determinations and retention strategy generation process. The entire workflow is designed to provide telecommunications providers with timely, accurate insights into customer churn risks and effective strategies for customer retention.

The flow diagram illustrates a comprehensive approach to customer churn management, integrating diverse data sources, advanced AI techniques, and machine learning models to identify at-risk customers and develop targeted retention strategies. The structured workflow ensures that each stage builds upon the previous one, creating a cohesive and effective system for predicting and addressing customer churn in telecommunications services.

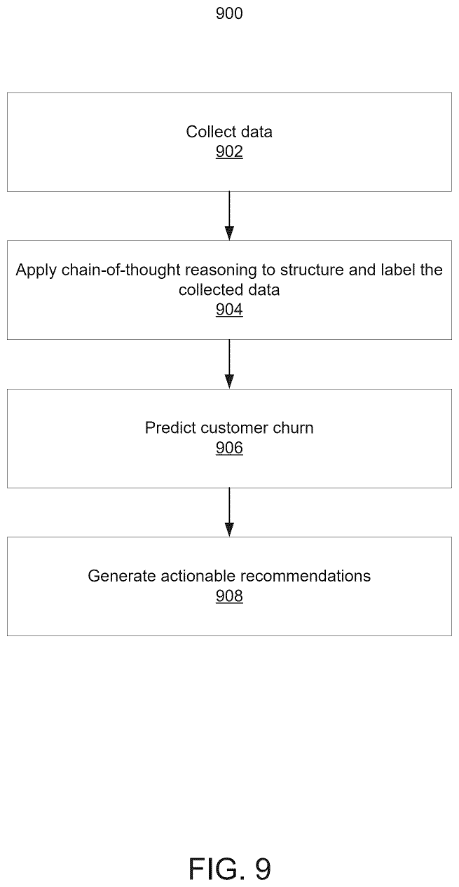

FIG. 9 illustrates a flowchart of methods 900 for predicting customer churn and generating retention strategies.

Data may be collected (block 902). The data may comprise real-time telemetry data and batch-processed customer interaction data. Collecting the data may result in collected data. The real-time network telemetry data may include metrics for latency, bandwidth utilization, and packet loss. The batch-processed customer interaction data includes customer care tickets, surveys, and emails.

Chain-of-thought reasoning may be applied to structure and label collected data (block 904). Applying chain-of-thought reasoning to structure and label the collected data may result in labeled data.

Customer churn may be predicted (block 906). Customer churn may be predicted using time-series regression models. The time-series regression models may be based on the labeled data. Predicting customer churn may result in churn predictions. Market trends and/or vendor performance data may be incorporated into the churn predictions. The market trends and/or vendor performance data may be integrated into churn predictions using an external data integrator. Integrating the market trends and/or vendor performance data into the churn predictions may result in incorporated external data.

Actionable recommendations may be generated (block 908). The actionable recommendations may be for customer retention. The actionable recommendations may be generated based on the churn predictions. The generating the actionable recommendations for customer retention may comprise generating retention strategies based on the incorporated external data. Integration of real-time and batch-processed data streams may be coordinated using a GenAI orchestrator. The coordinating the integration of the data streams may comprise dynamically adjusting data processing priorities based on detected patterns in customer behavior.

Although example blocks are shown, some implementations may include additional blocks, fewer blocks, different blocks, or differently arranged blocks than those depicted. Additionally, or alternatively, two or more of the blocks may be performed in parallel.

### EXAMPLES

Example Clause 1: A system comprising: a data ingestion module implemented on a computing platform and configured to collect and batch-processed customer interaction data and real-time or near real-time network telemetry data from distributed sources, resulting in collected data, wherein the data ingestion module is further configured to normalize the collected data, resulting in normalized data, and wherein the network telemetry data comprises at least latency, bandwidth utilization, and packet loss metrics; a generative artificial intelligence (GenAI) labeling agent implemented via a neural network framework, configured to apply structured chain-of-thought reasoning to categorize and annotate the normalized data into labeled datasets based on contextual features and temporal patterns; a machine learning (ML) module operatively coupled to the Gen AI labeling agent and configured to execute time-series regression models trained to predict customer churn probabilities using the labeled datasets, resulting in churn prediction; and a prescriptive GenAI agent configured to generate machine-interpretable retention strategies and actionable customer engagement recommendations based on output from the ML module, wherein the recommendations are delivered via an automated engagement system.
Example Clause 2: The system of Example Clause 1, wherein the data ingestion module is further configured to timestamp and format the collected data according to a unified schema to enable real-time or near real-time synchronization between telemetry and customer interaction datasets.
Example Clause 3: The system of Example Clause 1 or Example Clause 2, wherein the GenAI labeling agent utilizes a transformer-based neural network model trained to identify sentiment indicators, anomaly markers, and temporal dependencies within customer interaction records.
Example Clause 4: The system of any one of Example Clauses 1-3, wherein the ML module comprises a recurrent neural network (RNN) or long short-term memory (LSTM) network configured to process time-series sequences of labeled customer activity data.
Example Clause 5: The system of any one of Example Clauses 1-4, wherein the prescriptive GenAI agent is configured to rank customer retention recommendations based on a calculated retention efficacy score derived from prior action outcomes.
Example Clause 6: The system of any one of Example Clauses 1-5, further comprising a GenAI orchestrator configured to manage prioritization and parallelization of data labeling and model inference operations across distributed computing nodes.
Example Clause 7: The system of any one of Example Clauses 1-6, wherein the GenAI orchestrator dynamically allocates compute resources based on traffic load, model execution latency, and data freshness indicators.
Example Clause 8: The system of any one of Example Clauses 1-7, wherein the network telemetry data is sourced from customer premise equipment (CPE) and service provider infrastructure nodes, and is ingested via secure application programming interface (API) endpoints with low-latency protocols.
Example Clause 9: The system of any one of Example Clauses 1-8, wherein the customer interaction data comprises multi-channel inputs including emails, chat transcripts, call center logs, and structured survey responses.
Example Clause 10: The system of any one of Example Clauses 1-9, further comprising an external context integrator configured to incorporate third-party market trend data and vendor performance analytics into the churn prediction and retention recommendation process.
Example Clause 11: A method comprising: collecting real-time network telemetry data and batch-processed customer interaction data, resulting in collected data; applying chain-of-thought reasoning to structure and label the collected data, resulting in labeled data; predicting customer churn using time-series regression models based on the labeled data, resulting in churn predictions; and generating actionable recommendations for customer retention based on the churn predictions.
Example Clause 12: The method of Example Clause 11, further comprising coordinating integration of real-time and batch-processed data streams using a GenAI orchestrator.
Example Clause 13: The method of Example Clause 11 or Example Clause 12, wherein the coordinating the integration of the data streams comprises dynamically adjusting data processing priorities based on detected patterns in customer behavior.
Example Clause 14: The method of any one of Example Clauses 11-13, wherein the real-time network telemetry data includes metrics for latency, bandwidth utilization, and packet loss.
Example Clause 15: The method of any one of Example Clauses 11-14, wherein the batch-processed customer interaction data includes customer care tickets, surveys, and emails.
Example Clause 16: The method of any one of Example Clauses 11-15, further comprising incorporating market trends and vendor performance data into the churn predictions using an external data integrator, resulting in incorporated external data.
Example Clause 17: The method of any one of Example Clauses 11-16, wherein the generating the actionable recommendations for customer retention comprises generating retention strategies based on the incorporated external data.
Example Clause 18: A non-transitory computer-readable medium storing instructions that, when executed by a processor, cause the processor to perform operations for predicting customer churn and generating retention strategies, the operations comprising: orchestrating integration of real-time network telemetry data and batch-processed customer interaction data, resulting in integrated data; applying chain-of-thought reasoning to structure and label the integrated data, resulting in labeled data; predicting customer churn using time-series regression models based on the labeled data, resulting in churn predictions; and generating actionable recommendations for customer retention based on the churn predictions.
Example Clause 19: The non-transitory computer-readable medium of Example Clause 18, wherein orchestrating the integration of data comprises dynamically adjusting data processing priorities based on detected patterns in customer behavior.
Example Clause 20: The non-transitory computer-readable medium of Example Clause 18 or Example Clause 19, wherein the real-time network telemetry data includes metrics for latency, bandwidth utilization, and packet loss.
Example Clause 21: The non-transitory computer-readable medium of any one of Example Clauses 18-20, wherein the batch-processed customer interaction data includes customer care tickets, surveys, and emails.
Example Clause 22: The non-transitory computer-readable medium of any one of Example Clauses 18-21, the operations further comprising incorporating market trends and vendor performance data into the churn predictions.
Example Clause 23: The non-transitory computer-readable medium of any one of Example Clauses 18-22, wherein the generating the actionable recommendations for customer retention comprises generating retention strategies based on the incorporated market trends and the vendor performance data.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1-23. (canceled)

24. A method comprising:
receiving, from one or more sources, network telemetry data indicative of network performance metrics, and customer interaction data indicative of one or more of customer engagement or customer sentiment;
generating, using a correlation model and based on at least the network telemetry data and the customer interaction data, labeled data indicative of network performance and customer sentiment correlations;
determining, using the labeled data and one or more time-series regression models, one or more churn predictions indicative of a likelihood that a customer will discontinue service; and
outputting, to a user interface, the one or more churn predictions and one or more confidence scores associated with the one or more churn predictions;
outputting, to the user interface and based on at least the one or more churn predictions, one or more retention strategy recommendations.

25. The method of claim 24, further comprising: causing one or more of the retention strategy recommendations to be implemented.

26. The method of claim 24, wherein the network telemetry data is received in real time.

27. The method of claim 24, wherein the network telemetry data comprises at least one of latency, bandwidth utilization, and packet loss.

28. The method of claim 24, wherein the customer interaction data is batch-processed.

29. The method of claim 24, wherein the customer interaction data comprises at least one of call-center logs, chat transcripts, and survey responses.

30. The method of claim 24, wherein the correlation model is a chain-of-thought model.

31. The method of claim 24, further comprising incorporating external market-trend data and vendor-performance analytics into the labeled data using an external context integrator to refine the one or more churn predictions.

32. The method of claim 24, wherein outputting the churn predictions comprises ranking the churn predictions according to calculated confidence scores and presenting ranked churn predictions within an operational dashboard interface.

33. The method of claim 24, further comprising refining the correlation model and the time-series regression models based on feedback data representing outcomes of implemented retention strategies.

34. A non-transitory computer-readable medium storing a set of instructions, the set of instructions comprising:
one or more instructions that, when executed by one or more processors of a device, cause the device to:
receive, from one or more sources, network telemetry data indicative of network performance metrics, and customer interaction data indicative of one or more of customer engagement or customer sentiment;
generate, using a correlation model and based on at least the network telemetry data and the customer interaction data, labeled data indicative of network performance and customer sentiment correlations;
determine, using the labeled data and one or more time-series regression models, one or more churn predictions indicative of a likelihood that a customer will discontinue service; and
output, to a user interface, the one or more churn predictions and one or more confidence scores associated with the one or more churn predictions;
output, to the user interface and based on at least the one or more churn predictions, one or more retention strategy recommendations.

35. The non-transitory computer-readable medium of claim 34, wherein the one or more instructions further cause the device to: cause one or more of the retention strategy recommendations to be implemented.

36. The non-transitory computer-readable medium of claim 34, wherein the network telemetry data is received in real time.

37. The non-transitory computer-readable medium of claim 34, wherein the network telemetry data comprises at least one of latency, bandwidth utilization, and packet loss.

38. The non-transitory computer-readable medium of claim 34, wherein the customer interaction data comprises at least one of call-center logs, chat transcripts, and survey responses.

39. A system comprising:
one or more processors configured to:
receive, from one or more sources, network telemetry data indicative of network performance metrics, and customer interaction data indicative of one or more of customer engagement or customer sentiment;
generate, using a correlation model and based on at least the network telemetry data and the customer interaction data, labeled data indicative of network performance and customer sentiment correlations;
determine, using the labeled data and one or more time-series regression models, one or more churn predictions indicative of a likelihood that a customer will discontinue service; and
output, to a user interface, the one or more churn predictions and one or more confidence scores associated with the one or more churn predictions;
output, to the user interface and based on at least the one or more churn predictions, one or more retention strategy recommendations.

40. The system of claim 39, wherein the one or more processors are further configured to:
cause one or more of the retention strategy recommendations to be implemented.

41. The system of claim 39, wherein the customer interaction data comprises at least one of call-center logs, chat transcripts, and survey responses.

42. The system of claim 39, wherein the one or more processors, when outputting the churn predictions, are configured to rank the churn predictions according to calculated confidence scores and presenting ranked churn predictions within an operational dashboard interface.

43. The system of claim 39, wherein the one or more processors are further configured to:
refine the correlation model and the time-series regression models based on feedback data representing outcomes of implemented retention strategies.
